(19) United States
(12) Patent Application Publication
(10) Pub. No.: US 2018/0208082 A1
(43) Pub. Date: Jul. 26, 2018

(54) SEAT ARRANGEMENT FOR A VEHICLE, A VEHICLE WITH THE SEAT ARRANGEMENT AND A METHOD FOR ADJUSTING A VEHICLE SEAT OF A SEAT ARRANGEMENT

(71) Applicant: GM GLOBAL TECHNOLOGY OPERATIONS LLC, Detroit, MI (US)

(72) Inventors: Christian Kuhley, Gross-Gerau (DE); Juergen Maier, Weitersweiler (DE)

(73) Assignee: GM GLOBAL TECHNOLOGY OPERATIONS LLC, Detroit, MI (US)

(21) Appl. No.: 15/876,457

(22) Filed: Jan. 22, 2018

(30) Foreign Application Priority Data
Jan. 20, 2017 (DE) 102017000510.9

(51) Int. Cl. B60N 2/08; B60N 2/30; B60N 2/02

(52) U.S. Cl. CPC B60N 2/08; B60N 2/0244; B60N 2/0232; B60N 2/3011

(57) ABSTRACT

A seat arrangement for a vehicle includes a vehicle seat and a seat backrest. The seat backrest can be switched from an upright position into a folded position with an electric and/or electronic adjusting device for switching the seat backrest from the upright position into the folded position. The vehicle seat can be moved in a seat direction F with a mechanical traveling device for moving the vehicle seat in the seat direction depending on the position of the seat backrest.

### CROSS-REFERENCE TO RELATED APPLICATION

This application claims priority to German Patent Application No. 10 2017 000 510.9, filed Jan. 20, 2017, which is incorporated herein by reference in its entirety.

### TECHNICAL FIELD

This application pertains to a seat arrangement with an easy to adjust vehicle seat.

### BACKGROUND

Nowadays, nearly every vehicle has integrated into it vehicle seats that can be moved opposite the traveling direction of the vehicle, and whose seat backrest has an adjustable angle of inclination. Already known is to electrically and/or electronically initiate and execute the adjustment of the angle of inclination and movement of the vehicle seat in and/or opposite the traveling direction.

For example, publication WO 2015 148 774 A1 describes a vehicle seat whose seat surface and backrest can be adjusted by an electric drive. The vehicle seat can be moved via a gesture control, and the backrest inclination can be adjusted if a passenger wishes to enter the vehicle behind the vehicle seat.

### SUMMARY

A seat arrangement for a vehicle is disclosed, for example for a passenger car. The passenger car is preferably a coupe, in which a user enters through a driver or passenger side door of the vehicle, in order to sit on a seat of the rear seat row in the vehicle. The seat arrangement has a vehicle seat, which is configured as a seat of a front seat row in the vehicle, in particular as the driver side seat or passenger side seat. As an alternative or additional option, the vehicle seat can be configured as a seat of a rear seat row in the vehicle, in particular one of several rear seat rows.

The vehicle seat has a seat backrest, on which an occupant in the vehicle can rest his or her back. The seat backrest can be switched from an upright position into a folded position. In particular, while being switched from the upright position into the folded position, the seat backrest can be adjusted in its angle of inclination relative to a seat cushion of the vehicle seat on which the occupant sits with his or her buttocks.

This seat arrangement includes an electric and/or electronic adjustment device. The electric or electronic adjustment device is configured to switch the seat backrest of the vehicle seat from the upright position into the folded position.

The vehicle seat can be moved in a seat direction. The seat direction preferably corresponds to a direction in which an occupant sitting on the vehicle seat is looking. As an additional option, the seat direction corresponds to the traveling direction of the vehicle.

The seat arrangement preferably has a rail assembly with at least one rail. In particular, the vehicle seat can be moved along one or more rails in and opposite the seat direction. The seat arrangement has a mechanical traveling device. The mechanical traveling device is configured to move the vehicle seat along the rail(s) as a function of the position of the seat backrest.

The mechanical traveling device is preferably activated independently and/or automatically, in particular without any outside actions, depending on the position of the seat backrest, and move the vehicle seat. This advantageously makes it possible to provide a simple and cost-effective solution for comfortably adjusting the vehicle seat without any handling and/or effort. Comfort for a user of the vehicle with the seat arrangement can in this way be enhanced, if he or she must first adjust and move the vehicle seat in order to get into the vehicle and sit down on the seat of the rear seat row or one of the rear seat rows.

In a preferred embodiment of the present disclosure, the vehicle seat can be moved along the rail(s) by the mechanical traveling device exclusively during and/or after switching the seat backrest into the folded position. In particular, the seat backrest must first be moved from the upright position into the folded position before the mechanical traveling device can move the vehicle seat along the rail(s).

In a preferred structural implementation of the present disclosure, the mechanical traveling device has at least one spring mechanism. The spring mechanism is preferably configured to move the vehicle along the rail(s) exposed to a spring force. For example, the spring mechanism is arranged between the seat cushion of the vehicle seat and a vehicle floor of the vehicle. In particular, the spring mechanism is arranged adjacent to the rail(s). In particular, the spring mechanism extends commutated and/or parallel to the rail(s). It is especially preferred that the spring mechanism be fixed on the vehicle floor, for example together with the rail(s).

In a preferred embodiment of the present disclosure, the rail assembly has a locking system, which is configured to lock the vehicle seat, e.g., in a rearward position where the rail(s) is provided. The locking system is preferably unlocked by switching the seat backrest from the upright position into the folded position.

In particular, the vehicle seat is moved by the spring mechanism while exposed to a spring force with the locking system unlocked, automatically and/or independently. In particular, a preload of the spring mechanism is released when the locking system is unlocked. For example, the vehicle seat is moved in the seat direction from the rearward position into a forward position in the rail(s). As an option, the vehicle seat can be manually shifted opposite the seat direction out of the forward position and back into the rearward position.

A preferred structural embodiment of the present disclosure provides that the electric and/or electronic adjustment device have an operating unit and an actuator unit. In particular, the operating unit is configured to be operated by the user. The actuator unit is preferably configured to switch the seat backrest from the upright position into the folded position during and/or after activation of the operating device. For example, the actuator unit is configured as an electric motor unit. In particular, the actuator unit is activated by an electric input/output signal via a suitable electric interface, such as a standard two-pin input.

The seat arrangement optionally includes an additional spring mechanism for switching the seat backrest from an upright position into the folded position, by an additional spring force. For example, the additional spring mechanism is arranged in the seat backrest. The actuator unit is preferably operatively connected with the additional spring mechanism, e.g., via a Bowden cable or a lever unit. In particular, the actuator unit is activated during or after operating the operating unit, so that it releases a preload of the additional spring mechanism and initiates the switch from the upright position of the seat backrest into the folded position of the seat backrest. As an option, the seat backrest can be returned from the folded position into the upright position by manually straightening up the seat backrest.

For example, the operating unit is arranged on the seat backrest. The operating unit is preferably covered on the seat backrest, wherein it is located on a cushion of the seat backrest under an upholstery cover of the seat backrest. As an alternative, the operating unit can be uncovered on the seat backrest. In this case, the operating unit is situated on the upholstery cover and/or integrated into a recess in the upholstery cover. In this way, the operating unit, after opening a vehicle door of the vehicle, is arranged in a readily accessible handling area, and can thus be quickly and easily reached.

Within the framework of the method, the operating unit can be configured as at least a control knob or control switch, or as a radio remote control for activating the actuator unit.

Alternatively, it is especially preferred that the operating unit be configured as a sensor device. In particular in this case, the seat arrangement has a controller and/or evaluator. The sensor device is preferably configured to acquire a triggering process. In particular, the controller and/or evaluator actuates the actuator unit based on the triggering process acquired by the sensor device. For example, the triggering process is a human gesture, a word or word sequence spoken by the user, or a noise generated by the user. In particular, a specific voice command or a sequence of voice commands can be involved. Speaking a free text is also possible. In particular, the word, word sequence and/or noise is stored in the controller and/or evaluator.

The sensor device may include a capacitive sensor, an optical sensor and/or a microphone. In particular, the capacitive sensor or the optical sensor acquires the human gesture performed by the user as the triggering process. For example, the human gesture is a wiping gesture by a hand or a swinging motion by a foot of the user. For example, if the sensor device has a microphone, the triggering process is the spoken word, the spoken word sequence and/or the noise, for example the clapping hands of the user. Involved in this case is a voice and/or noise controller.

In another possible embodiment of the present disclosure, the seat arrangement has an indicator. The indicator is preferably configured to display a notification about the presence, positioning and/or functionality of the operating unit. In particular, the indicator is situated where the operating unit is located, so as to indicate it. In particular, this is especially helpful if the operating unit is hidden by the upholstery cover or arranged outside of the direct field of view of the user, e.g., on the vehicle door sill.

The indicator is preferably configured as a patch, an emblem or a sticker on the upholstery cover. Also possible is a color marking in the form of an imprint. Alternatively, the indicator can be configured as a lighting assembly, e.g., with at least one light emitting diode or with at least one SMD strip. The lighting assembly preferably emits color light so as to indicate the functionality of the electric and/or electronic adjusting device by a green light, and for example to indicate a deactivation of the adjusting device with a red light. Also possible is to emit a running light. In particular, the indicator is arranged on or in the upholstery cover, or where the operating unit is integrated into the vehicle. It is advantageous that the user can quickly and easily find the operating unit via the indicator, and as an additional option can detect its functionality by the emitted light colors.

It is advantageous that the seat arrangement according to the present disclosure eliminates the need for at least one mechanical operating lever for adjusting the seat inclination of the seat backrest and/or the sitting position of the vehicle seat. The seat contour of a vehicle seat no longer has to be adjusted. As a result, the vehicle seat can be configured in an optically advantageous manner. In addition, the number of components can be reduced, since the same cushions and upholstery covers for vehicle seats can be used in three-door vehicles and, for example, in five-door vehicles.

The present disclosure further provides a vehicle with the seat arrangement according to the preceding description. The vehicle preferably has a passenger compartment, a vehicle body and at least one vehicle door. For example, the vehicle door is configured as the driver or passenger door. Alternatively, the vehicle door can be configured as a rear vehicle door if the vehicle has several rear seat rows. The vehicle door can advantageously be moved from an open state into a closed state.

The seat arrangement is preferably integrated into the passenger compartment. In particular, the operating unit is arranged in the passenger compartment, for example on the vehicle seat, in particular on the seat backrest, or on the vehicle body, for example on the vehicle door sill.

In the event that the operating unit is arranged in the passenger compartment, it is preferred that the passenger perform the wiping gesture with the hand over the operating unit, in particular over the at least one haptic or optical sensor, so as to operate it and activate the actuator unit. If the operating unit in this embodiment is located on the vehicle body, in particular on and/or under the sill, it is especially preferred that the passenger performs the swinging motion with his or her foot under the sill. If the at least one optical sensor is arranged on the underside of the sill, it is preferred that the latter also can be protected against contaminants by a protective device, so as to maintain functionality.

In the embodiment of the operating unit as the at least one microphone, the latter can be arranged at a suitable location in the passenger compartment or on the vehicle body. When positioning the at least one microphone, care must be taken in particular that the word, word sequence or noise spoken or generated by the user, especially with the vehicle door open, can be readily and clearly acquired by the microphone. In particular, the microphone should be located in the area of the vehicle body adjacent to the vehicle door, e.g., on the door sill, or on the vehicle door itself. Another way to prevent the electric adjusting device from being erroneously tripped is to provide word and/or noise filters in the controller and/or evaluator.

In a preferred embodiment of the present disclosure, the controller and/or evaluator activates or deactivates the electric and/or electronic adjusting device depending on the state of the vehicle door. In particular, the adjusting device is only activated if the vehicle door is in the open state. This activation based on the state of the vehicle door is preferably used when configuring the operating unit as a sensor device, which has the microphone. In particular, this prevents the actuator unit from being erroneously activated with the vehicle door closed by words and/or noises penetrating into the passenger compartment from the environment of the vehicle.

Within the framework of the present disclosure, it is also possible that the actuator unit only be activated within a specific period of time, for example within 20 seconds, after opening the vehicle door, and then automatically deactivates itself. As a consequence, the period of time for which the voice and/or noise controller can actively receive commands is limited. This makes it possible to achieve a strong statistical reduction in erroneous tripping.

The adjusting device preferably also remains active with the vehicle door closed if the operating unit as a sensor device has the capacitive sensor or the optical sensor. As a result, the vehicle seat can also be adjusted and moved from the rear seat row.

In a preferred implementation of the present disclosure, the indicator, in particular configured as an LED array or SMD strip, emits a signal light that signals to the user that voice and/or noise control and/or gesture control is possible or no longer possible. In particular, the indicator is actuated by the controller and/or evaluator depending on the state of the vehicle door. For example, the indicator indicates that voice and/or noise control is possible with the vehicle door open. In particular after the prescribed period of time has elapsed, the indicator indicates that voice and/or noise control is no longer possible.

In a preferred implementation of the present disclosure, the seat arrangement has an emergency unlocking system. The emergency unlocking system is preferably configured to ensure that the seat backrest is adjusted from the upright position into the folded position and associated therewith that the vehicle seat moves along the rail(s), even if the electric and/or electronic adjusting device is not functional or inactive. For example, this can be the case intentionally due to the closed vehicle door or unintentionally, due to a defect in the electrical system of the vehicle. For example, the emergency unlocking system has a hand strap, a lever, a thumbwheel or some other suitable handling unit for activating another Bowden cable or some other lever unit of the emergency unlocking system, with which the seat backrest can be folded and/or with which the unlocking system can be unlocked, so that the vehicle seat can be moved. In particular, the unlocking system can be equally unlocked by the emergency unlocking system from the rear seat row or, with the vehicle door open, from outside of the vehicle.

### BRIEF DESCRIPTION OF THE DRAWINGS

The present disclosure will hereinafter be described in conjunction with the following drawing figures, wherein like numerals denote like elements.

FIG. 1 is a top view of a seat arrangement for a vehicle with a vehicle seat;

FIG. 2 is a rail assembly of the seat arrangement from FIG. 1 with a rail means and a spring mechanism; and

FIG. 3 is a section of a framework of a seat backrest of the vehicle seat from FIG. 1, wherein an actuator unit for adjusting the seat backrest is arranged in the section.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

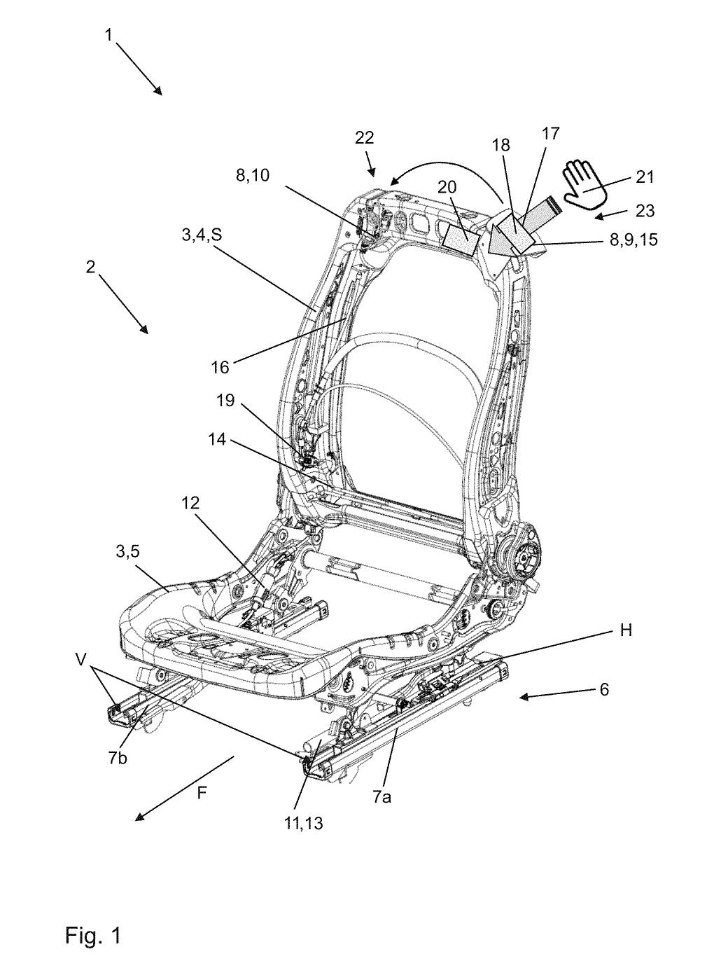

FIG. 1 presents a top view of a seat arrangement 1 for a vehicle, in particular for a passenger car, which is configured like a coupe. The seat arrangement 1 has a vehicle seat 2, wherein a framework 3 of the vehicle seat 2 is depicted. The vehicle seat 2 has a seat backrest 4 and a seat cushion 5. The seat backrest 4 can be switched from an upright position S shown on FIG. 1 into a folded position (not depicted). In particular, the seat backrest 3 can be adjusted at an angle of inclination relative to the seat cushion 4.

The seat arrangement 1 has a rail assembly 6. The rail assembly 6 has a first and second rail 7a, 7b. In the first and second rail 7a, 7b, the vehicle seat 2 can be moved in and opposite a seat direction F from a rearward position H into a forward position V along the rail means 7a, 7b.

The seat arrangement 1 has an electric and/or electronic adjusting device 8. The adjusting device 8 is configured to switch the seat backrest 4 from the upright position S into the folded position. For this purpose, the electric and/or electronic adjusting device 8 has an operating unit 9 and an actuator unit 10.

The seat arrangement 1 has a mechanical displacement device 11. The mechanical displacement device 11 is configured to move the vehicle seats 2 in the seat direction F, in particular along the rail 7a, 7b, depending on the position of the seat backrest 4. For this purpose, the mechanical displacement device 11 has a spring mechanism 13.

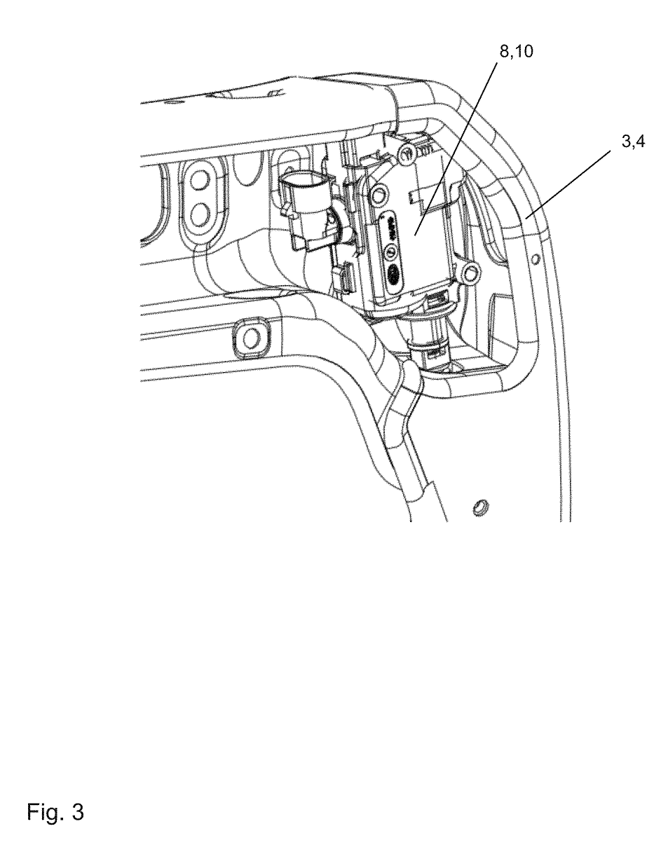

For example, the actuator unit 10 is configured as an electric motor, which can be activated by operating and/or activating the operating unit 9, in particular by an electric signal thereby generated, e.g., via a standard two-pin input. FIG. 3 presents a top view from behind of a cutout from the seat backrest 4 of the vehicle seat 2 on FIG. 1. The actuator unit 10 is arranged in a first upper corner area 22 of the framework 3 of the seat backrest.

The actuator unit 10 is operatively connected with an additional spring mechanism 14 of the seat arrangement. The additional spring mechanism 14 is integrated into the seat backrest 4. The actuator unit 10 is coupled with the additional spring mechanism 14 via a Bowden cable 16 and a recliner 19 of the seat arrangement. When the Bowden cable 16 is exposed to the tensile force generated and/or transmitted by the activated actuator unit 10, the recliner 19 releases the preload of the additional spring mechanism 14, so that the seat backrest 4 is switched by an additional spring force of the additional spring mechanism 14 from the upright position S into the folded position.

The operating unit 8 is arranged in a second upper corner area 23 of the framework 3 of the seat backrest 4. The second upper corner area 23 is situated adjacent to a vehicle door, through which a user of the seat arrangement 1 gets into the vehicle so as to sit down on the vehicle seat 2. The vehicle door is integrated into a vehicle body, wherein a vehicle body sill runs under the vehicle door. The vehicle door is configured as a driver side door or passenger side door if the vehicle has only a rear seat row. The user enters the passenger compartment of the vehicle through the driver side door or passenger side door in order to sit down on a seat of the rear seat row. To this end, he or she folds over the seat backrest 4, so that the vehicle seat 2 is moved into the forward position V. If the vehicle has several rear seat rows, the vehicle door can also be a rear door. The vehicle seat 2 to be adjusted and moved is then situated adjacent to the rear door.

The operating unit 8 is arranged in the second upper corner area 23 of the seat backrest 4 on a seat cushion (not shown) and under an upholstery cover of the seat backrest 4 (not shown), so that it cannot be seen from a passenger compartment of the vehicle and is hidden by the upholstery cover.

As an alternative to being positioned hidden on the seat backrest 4, the operating unit 8 can also be hidden in an entry area of the vehicle or on the vehicle body, e.g., under the sill. The seat arrangement 1 has an indicator 18 to indicate the presence, positioning and/or functionality of the operating unit 9 in the upper corner area of the seat backrest 4 or on another hidden location in the vehicle.

In an alternative exemplary embodiment, the operating unit 9 can also be readily visibly located in the passenger compartment of the vehicle, in particular on the seat backrest 4 or in the area of the vehicle door. In this case, the indicator can potentially also be omitted.

The operating unit 9 is configured as a sensor device 15 for acquiring a triggering process 17, e.g., a gesture and/or a spoken word, a spoken word sequence and/or a noise generated by the user. The sensor device 15 has at least one haptic and/or optical sensor for acquiring the gesture. In order to acquire the spoken word, word sequence and/or noise, the sensor device 15 has at least one microphone. In an alternative exemplary embodiment, the operating unit 9 can be configured as a control switch, control lever or radio remote control, with which the user can activate the actuator unit 10.

The seat arrangement 1 has a controller and/or evaluator 20 for evaluating the triggering process 17 acquired by the sensor device 15, and for activating the actuator unit 10 based on the triggering process 17. In the event the triggering process 17 is the spoken word, word sequence and/or noise, a voice and/or noise controller of the actuator unit 10 is involved. In particular, precise voice commands or distinct noises, e.g., hands clapping twice, are stored in the controller and/or evaluator 20.

If the user initiates the triggering process 17 according to FIG. 1 and performs a wiping gesture with one hand 21 as the triggering process 17 over the optical or capacitive sensor, this is acquired by the sensor device 15 with the optical and/or capacitive sensor. The controller and/or evaluator 20 evaluates the triggering process 17, and thereupon activates the actuator unit 10, which actuates the Bowden cable 16 and releases the preload of the additional spring mechanism 14 to switch the seat backrest 4 from the upright position S into the folded position.

In particular if the adjusting device 8 is actuated and/or activated by the voice and/or noise controller, security measures should be taken to prevent the adjusting device 8 from being erroneously triggered. For example, such a security measure can provide that the controller and/or evaluator 20 activates the adjusting device 8, in particular the actuator unit 10, depending on a state of the vehicle door located the closest to the sensor device 15. For example, the actuator unit 10 is only activated if the vehicle door is in the open state, or if the vehicle door has only been opened for a predetermined period of time stored in the controller and/or evaluator. If the vehicle door remains open longer than envisaged by the predetermined period of time, or if the vehicle door is closed, the actuator unit 10 is not activated, even though a triggering process 17 might have taken place.

The seat arrangement 1 has a locking system 12. The locking system 12 fixes the vehicle seat 2 in the two rail means 7a, 7b, and blocks it from moving. Only once the locking system 12 has been unlocked can the vehicle seat 2 be moved by the mechanical traveling device 11 along the rail means 7a, 7b in the traveling direction F, preferably until into the forward position V.

A corresponding mechanism, e.g., a leverage effect, is used to unlock the locking system 12 during and/or after the seat backrest 4 has been switched from the upright position S into the folded position. As a result, the mechanical traveling device 11 initiates the automatic or independent movement of the vehicle seat 2 along the rail 7a, 7b. In particular, moving the vehicle seat 2 in the seat direction F is directly coupled with unlocking the locking system 12.

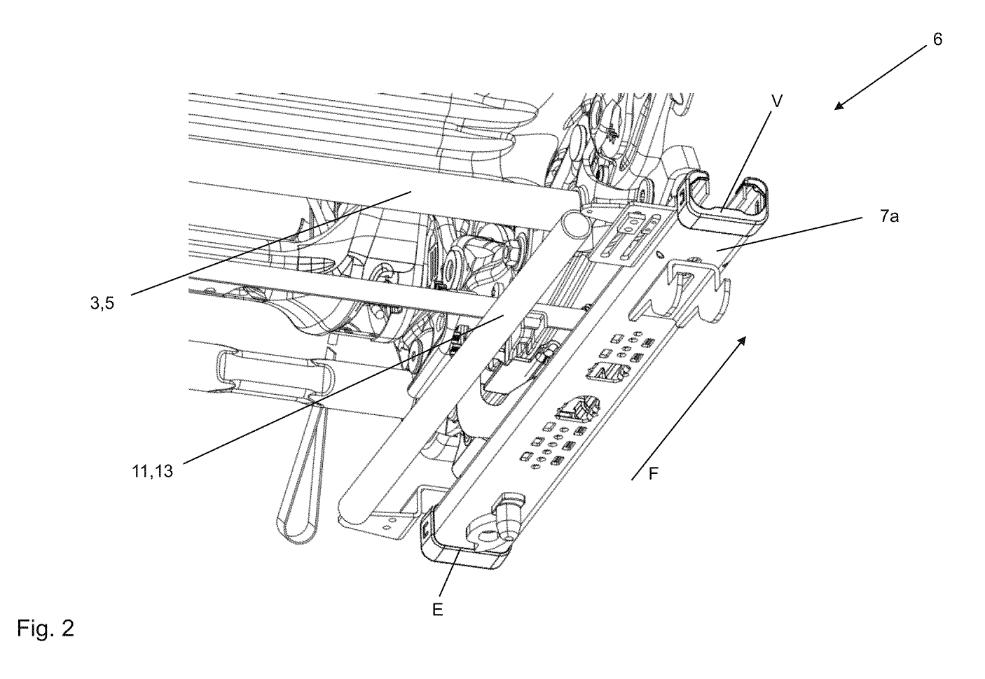

FIG. 2 presents a top view from below of the first rail means 7a and of the mechanical traveling device 11. The vehicle seat 2 is displaceably mounted on the rail means 7a, 7b. However, the locking system 12 (FIG. 1) in the rail means 7a, 7b blocks any movement by the vehicle seat 2.

The mechanical traveling device 11 has the spring mechanism 13. The spring mechanism 13 is located under the seat cushion 15 and extends commutated and/or parallel to the first and second rail unit 7a, 7b. The spring mechanism 13 is fastened to a vehicle floor of the vehicle by a first rail 7a. The spring mechanism 13 is preloaded if the vehicle seat 2 is situated in the rearward position H, and the seat backrest 4 assumes the upright position S. As a consequence, a spring force directed toward the front in the traveling direction F acts on the vehicle seat 2.

During and/or after unlocking the locking system 12, the vehicle seat 2 blocked in the rail means 7a, 7b is released. The spring force moves the vehicle seat 2 along the rails 7a, 7b in the traveling direction F, preferably until into the forward position V.

As a consequence, moving the vehicle seat 2 with the mechanical traveling device 11 is permanently coupled with switching the seat backrest 4 from the upright position S into the folded position, and with the resultant unlocking of the locking system.

The indicator 18 depicted on FIG. 1 can be configured as an emblem, a patch or a sticker, and be applied to the upholstery cover. Alternatively, a symbol or logo can be incorporated into the upholstery cover, so as to draw the attention of the user to the sensor device 15 hidden underneath it.

Alternatively, the indicator 18 can be configured as an illuminating device with a plurality of light-emitting diodes, or with at least one SMD strip. Also possible is a configuration of the illuminating device as a display. The illuminating device as an indicator 18 is preferably located where the sensor device 15 is in particular hidden from view. The illuminating device is actuated by the controller and/or evaluator 20.

For example, the illuminating device emits light in a first color if the adjusting device 8 is active and/or functional. If the adjusting device 8 is inactive or defective, the illuminating device emits no light, or emits a light of a second color. A running light, blinking light and/or an image and/or text display can also be output, so as to provide corresponding information about the presence, positioning and/or functionality of the adjusting device.

If the functionality and/or activity of the adjusting device 8 is actuated based on the state of the vehicle door, the controller and/or evaluator 20 correspondingly actuates the indicator 18 as an illuminating device. In particular, the indicator 18 is actuated in such a way as to display the activity and/or functionality when the vehicle door is open and/or if the time for which the vehicle door has been open still lies within the predetermined period of time. If the vehicle door is closed and/or if the predetermined period of time has been exceeded, the controller and/or evaluator 20 actuates the indicator 18 as an illuminating device to display the inactivity.

The seat arrangement 1 has an emergency unlocking system (not shown). If the electric and/or electronic adjusting device 8 is not functional or inactive, e.g., due to a control action with the door closed or due to a defect in the electrical system of the vehicle, the user can use the emergency unlocking system to manually switch the seat backrest 4 from the upright position S into the folded position, so that the permanent coupling with the mechanical adjusting device 8 causes the vehicle seat 2 to move in the seat direction F. The emergency unlocking system has a hand strap, a lever, a thumbwheel or some other suitable handling unit for the user, with which he or she can activate another Bowden cable or some other lever unit of the emergency unlocking system, so as to switch the seat backrest into the folded state. If necessary, the emergency unlocking system can be activated from outside of the vehicle and from the passenger compartment with the vehicle door open, in particular from a seat row arranged opposite the seat direction F behind the vehicle seat 2.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. A seat arrangement for a vehicle comprising:
a vehicle seat movable in a seat direction and having a seat backrest positionable between an upright position and a folded position;
an adjusting device configured to switch the seat backrest from the upright position into the folded position; and
a mechanical traveling device configured to move the vehicle seat in the seat direction in response to the position of the seat backrest.

17. The seat arrangement according to claim 16, wherein mechanical traveling device is configured to move the vehicle seat exclusively when the seat backrest switches from the upright position into the folded position.

18. The seat arrangement according to claim 16, further comprising a rail assembly with at least one rail and a spring mechanism for biasing the vehicle seat in the seat direction with a spring force along the at least one rail.

19. The seat arrangement according to claim 18, wherein the rail assembly comprises a locking system configured to lock the vehicle seat in the at least one rail, wherein the locking system is unlocked by switching the seat backrest from the upright position into the folded position, so that the vehicle seat is moved by the mechanical traveling device when the locking system is unlocked.

20. The seat arrangement according to claim 16, wherein the adjusting device comprises an operating unit and an actuator unit, wherein the actuator unit is configured to switch the seat backrest from the upright position into the folded position when activating the operating unit.

21. The seat arrangement according to claim 20, wherein the operating unit is situated on the seat backrest.

22. The seat arrangement according to claim 20 wherein the operating unit comprises an operator configured to activate the actuator unit and selected from the group consisting of a control knob, a switch, or a radio remote control.

23. The seat arrangement according to claim 20, wherein the operating unit comprises a sensor device configured to acquire a triggering process which activates the actuator unit.

24. The seat arrangement according to claim 23, wherein the sensor device is selected from the group consisting of a capacitive sensor, an optical sensor, a microphone or a combination thereof.

25. The seat arrangement according to claim 23, wherein the triggering process is selected from the group consisting of a human gesture, a spoken word, a spoken word sequence, a noise or a combination thereof.

26. The seat arrangement according to claim 20, wherein the seat arrangement comprises an indicator configured to display information about a state of the operating unit.

27. A vehicle comprising a vehicle body having a first seat arrangement and a second seat arrangement located behind the first seat arrangement, wherein the first seat arrangement includes:
a vehicle seat movable in a seat direction and having a seat backrest positionable between an upright position and a folded position;
an adjusting device including an operating unit having an operator configured to activate the actuator unit and a sensor device configured to acquire a triggering process;
an actuator unit configured to switch the seat backrest from the upright position into the folded position when activating the operating unit in response to the triggering process; and
a mechanical traveling device configured to move the vehicle seat in the seat direction in response to the position of the seat backrest.

28. The vehicle according to claim 27, wherein the vehicle body comprises a passenger compartment and the operating unit is situated in the passenger compartment.

29. The vehicle according to claim 27, further comprising a vehicle door positionable between an open state into a closed state, wherein the operator is configured to activate the adjusting device based on the state of the vehicle door.

30. The vehicle according to claim 27 wherein the operating unit comprises an operator configured to activate the actuator unit and selected from the group consisting of a control knob, a switch, or a radio remote control.

31. The vehicle according to claim 27, wherein the operating unit comprises a sensor device configured to acquire a triggering process which activates the actuator unit.

32. The vehicle according to claim 31, wherein the sensor device is selected from the group consisting of a capacitive sensor, an optical sensor, a microphone or a combination thereof.

33. The vehicle according to claim 27, wherein the triggering process is selected from the group consisting of a human gesture, a spoken word, a spoken word sequence, a noise or a combination thereof.

34. The vehicle according to claim 27, wherein the seat arrangement comprises an indicator configured to display information about a state of the operating unit.
